(19) United States
(12) Patent Application Publication
(10) Pub. No.: US 2008/0126317 A1
(43) Pub. Date: May 29, 2008

(54) METHOD AND SYSTEM FOR CONVERTING SOURCE DATA FILES INTO DATABASE QUERY LANGUAGE

(76) Inventors: Adam David Stout, Poway, CA (US); David Eugene Lovett, San Diego, CA (US)

Correspondence Address: JAMES M. STOVER;TERADATA CORPORATION, 2835 MIAMI VILLAGE DRIVE, MIAMISBURG, OH, 45342, US

(21) Appl. No.: 11/772,983

(22) Filed: Jul. 3, 2007

Related U.S. Application Data
(60) Provisional application No. 60/819,481, filed on Jul. 7, 2006.

(51) Int. Cl. G06F 7/06

(52) U.S. Cl. 707/3; 707/E17.127

(57) ABSTRACT

A method and system for converting source data files into executable statements in a database query language such as SQL. The source data files include files created in an extensible language format such as XML that is lexically and/or structurally dissimilar to the database query language into which the source data file is to be converted. A library of transformations is maintained in the form of style sheets for performing formatting transformations on the source data files. Typically the library comprises one or more Extensible Stylesheet Language (XSL) stylesheets. The one or more stylesheets are applied to the source data file by a transformation engine such as an Extensible Stylesheet Language Transformation (XSLT) engine. The application of the one or more stylesheets from the library of transformations results in one or more executable statements in the desired database query language, which can then be sent to and executed by a Database Management System (DBMS). These techniques can be used to simultaneously generate a wide variety of database query language statements from XML and XSLT files and are well suited to the trickle feeding of data that has been encapsulated in XML to a data warehouse by, for example, performing single row inserts.

### BACKGROUND

Computer systems generally include one or more processors interfaced to a temporary data storage device such as a memory device and one or more persistent data storage devices such as disk drives. Data is usually transferred between the memory device and the disk drives over a communications bus or similar. Once data has been transferred from a disk drive to a memory device accessible by a processor, database software is then able to examine the data to determine if it satisfies the conditions of a query.

A database is a collection of stored data on one or more of the above disk drives. The stored data is logically related and is accessible by one or more users. A popular type of database is the relational database management system (RDBMS) which includes relational tables made up of rows and columns (also referred to as tuples and attributes). Each row represents an occurrence of an entity defined by a table, with an entity being a person, place, thing, or other object about which the table contains information. To extract data from or to update a relational table in an RDBMS, queries according to a standard database-query language (eg structured query language or SQL) are used. Examples of SQL statements include INSERT, SELECT, UPDATE, and DELETE.

Often it is desirable for a computer system to be capable of receiving database queries from remote locations and from different software applications. Extensible Markup Language (XML) is used by some computer applications for encapsulating data, that is, capturing information and imposing structures on captured information. However, to convert data encapsulated in an XML file into one or more queries appropriate for extracting data from or updating a table in an RDBMS, can be onerous. Typically a purpose built parser must be created to parse a source XML data file from a particular source or application and convert the data contained in the data file into a database friendly format such as comma separated values (CSV).

### SUMMARY

Described below is a method and system for converting source data files into executable statements in a database query language such as SQL. The source data files include files created in an extensible language format such as XML that is lexically and/or structurally dissimilar to the database query language into which the source data file is to be converted. A library of transformations is maintained in the form of style sheets for performing formatting transformations on the source data files. Typically the library comprises one or more Extensible Stylesheet Language (XSL) stylesheets. The one or more stylesheets are applied to the source data file by a transformation engine such as an Extensible Stylesheet Language Transformation (XSLT) engine. The application of the one or more stylesheets from the library of transformations results in one or more executable statements in the desired database query language, which can then be sent to and executed by a Database Management System (DBMS).

The techniques described below can be used to simultaneously generate a wide variety of database query language statements from XML and XSLT files and are well suited to the trickle feeding of data that has been encapsulated in XML to a data warehouse by, for example, performing single row inserts.

### BRIEF DESCRIPTION OF THE DRAWINGS

FIG. 1 is a block diagram of a computer system in which the techniques described below are implemented.

FIG. 2 is a block diagram of an exemplary large computer system in which the techniques described below are implemented.

FIG. 3 is a block diagram illustrating the transformation of a source XML data file into an executable database query language statement in accordance with the present invention.

### DETAILED DESCRIPTION

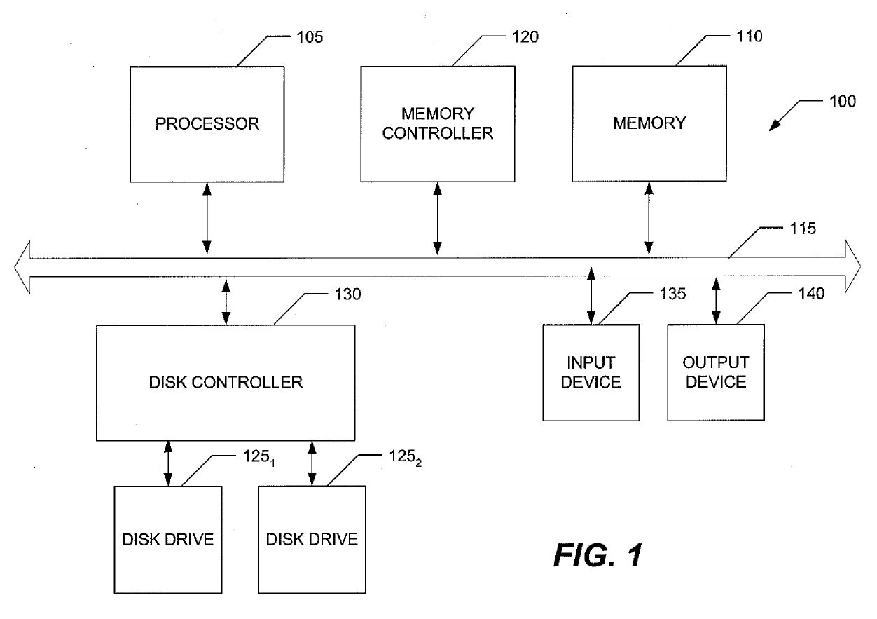

FIG. 1 shows a computer system 100 suitable for implementation of a method of using XSLT to load data into and retrieve data from an RDBMS based on XML data files. The system 100 includes one or more processors 105 that receive data and program instructions from a temporary data storage device, such as a memory device 110, over a communications bus 115. A memory controller 120 governs the flow of data into and out of the memory device 110. The system 100 also includes one or more persistent data storage devices, such as disk drives 125₁, and 125₂ that store chunks of data or data objects in a manner prescribed by one or more disk controllers 130. One or more input devices 135, such as a mouse and a keyboard, and output devices 140, such as a monitor and a printer, allow the computer system to interact with a human user and with other computers.

The disk controller 130 receives requests from the memory controller 120 to store data objects on the disk drives 125 and to retrieve data objects from the disk drives.

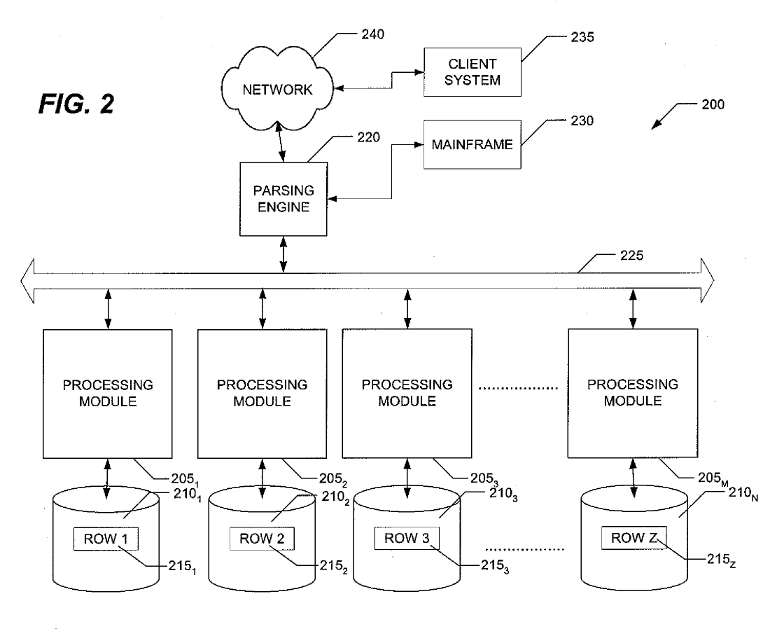

While FIG. 1 shows a sample computer system, FIG. 2 shows an example of a database system 200, such as a Teradata Active Data Warehousing System available from NCR Corporation, in which the techniques described below are suited for implementation. In database system 200, vast amounts of data are stored on many disk-storage facilities that are managed by many processing units. In this example the data warehouse 200 includes a Relational Database Management System (RDBMS) built upon a Massively Parallel Processing (MPP) platform.

Other types of database systems, such as Object-Relational Database Management Systems (ORDMS) or those built on Symmetric Multi-Processing (SMP) platforms, are also suited for use here.

The database 200 includes one or more processing modules 205_{1 . . . M} that manage the storage and retrieval of data in data storage facilities 210_{1 . . . N}. Each of the processing modules 205_{1 . . . M} manages a portion of a database that is stored in a corresponding one of the data storage facilities 210_{1 . . . N}. Each of the data storage facilities 210_{1 . . . N} includes one or more disk drives.

The system stores data in one or more tables in the data storage facilities 210_{1 . . . N}. The rows 215_{1 . . . Z} of the tables are stored across multiple data storage facilities 210_{1 . . . N} to ensure that the system workload is distributed evenly across the processing modules 205_{1 . . . N}. A parsing engine 220 organizes the storage of data and the distribution of table rows 215_{1 . . . Z} among the processing modules 205_{1 . . . N}. The parsing engine 220 also co-ordinates the retrieval of data from the data storage facilities 210_{1 . . . N} over network 225 in response to queries received from a user at a mainframe 230 or a client computer 235 connected to a network 240. The database system 200 usually receives queries and commands to build, access, and amend tables in a standard format, such as SQL.

The techniques described below utilize an Extensible Stylesheet Language (XSL) library to enable a computer system to receive XML data files and convert them into appropriate database queries for delivery to parsing engine 220, thus providing executable commands to build, access, and amend the tables of a database. The techniques provided have the potential to simplify the process of converting XML source files into database query language statements. The techniques are flexible enough to be used for a wide variety of resulting database query statements but are simple to use and do not require the extensive mapping of individual elements of XML source files previously required. The techniques are particularly well suited to trickle feeding a data warehouse with data that has been encapsulated in XML.

XSL is an XML based language that may be used to express Extensible Stylesheet Language Transformations (XSLT).

A transformation expressed in XSLT provides rules for transforming a source data file into a resulting data file. The transformation is achieved by matching specified patterns in the source data file and applying transformations stipulated in templates of the XSLT. A template is instantiated to create part of the resulting data file. A stylesheet can be applied to a wide variety of source data files that have similar structures.

Transformations expressed in XSLT are called stylesheets because where XSLT is used to transform XML statements into the XSL formatting vocabulary, the transformation functions as a stylesheet.

A template can contain elements that specify literal translations of part or a whole of a source data file or can contain elements from the XSLT namespace that are instructions for creating fragments of a resulting file or a mixture of the two. A prefix of xsl: is used to refer to elements in the XSLT namespace, which is located at http://www.w3.org/1999/XSL/Transform.

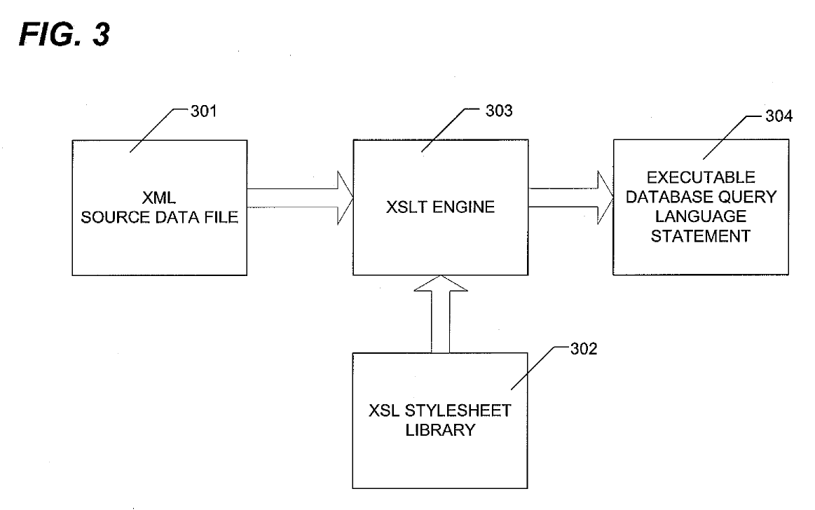

FIG. 3 shows a block diagram illustrating the conversion process in accordance with the present invention. Source data file 301 contains data encapsulated in XML. The encapsulated data is provided in order to access or modify data tables managed by a DBMS but is not suitable for sending to the DBMS in its encapsulated form.

In order to transform the XML source data file into a resulting data file in a database query language that is understood by the DBMS, an XSL library 302 of stylesheets is maintained. The stylesheets in the library 302 are configured to provide transformations of encapsulated data in XML data files into statements in an appropriate database query language. To facilitate the transformation, source data files may specify one or more stylesheets from the library that are to be used to perform the transformation. This is done by designating the source data file to be an instance of the one or more appropriate stylesheets. This mechanism also facilitates the transformation of XML source files into appropriate executable query statements for any number of different databases and database language queries by adding new stylesheets to the library 302 or modifying the existing stylesheets in the library. Substantial amounts of programming that would be required to perform such a variety of transformations using a traditional parser can therefore be avoided.

The XML source file 301 is provided to an XSLT engine 303 which processes the source file with reference to the stylesheets in the XSL library 302. The result of this processing is an executable statement 304 in a database query language such as SQL.

Some examples of stylesheets for a library 302, XML source files 301, and resulting database query language statements 304 are set out below. The following examples are not intended to be exhaustive or in any way limiting on the scope of the invention, but are provided only to illustrate the techniques described in this specification.

The following source data encapsulates a request to update the password for a particular user in XML:

<?xml version=“1.0” ?>
<?xml-stylesheet type=“text/xsl”
href=“passwordreset.1.0.xsl”?>
<message xmlns:xsi=“http://www.w3.org/2001/XMLSchema
instance”
xsi:noNamespaceSchemaLocation=“http://ttc.sandiegoca.ncr.com/
schema/user/passwordreset.1.0.xsd”>
<user username=“myuserid” newpass=“mynewpass”/>
</message>

The following stylesheet is applied to the source data above to obtain an executable statement to send to the DBMS:

```
<?xml version=‘1.0’?>
<xsl:stylesheet version=“1.0”
xmlns:xsl=“http://www.w3.org/1999/XSL/Transform”>
    <xsl:output method=“html” indent=“yes”/>
    <xsl:preserve-space elements=“*”/>
    <xsl:template match=“/”>
      <xsl:apply-templates/>
    </xsl:template>
    <xsl:template match=“user”>
      MODIFY USER <xsl:value-of select=“@username”/> AS
PASSWORD = <xsl:value-of select=“@newpass”/>
      ;
    </xsl:template>
</xsl:stylesheet>
```

The statement that would result from an XSLT engine processing the source data with reference to the stylesheet above would be the following:

MODIFY USER myuserid AS PASSWORD mynewpass

The following source data provides another simple example. In this example the source data encapsulates an SQL SELECT statement:

<?xml version=“1.0” encoding=“UTF-8”?>
<?xml-stylesheet type=“text/xsl” hrefr=“rawsql.1.0.xsl”?>
<message xmlns:xsi=“http://www.w3.org/2001/XMLSchema-
instance”
xsi:noNamespaceSchemaLocation=“http://ttc.sandiegoca.ncr.com/
schema/sql/rawsql.1.0.xsd”>
<sql>SELECT * FROM DBC.DBCINFO;</sql>
</message>

The following stylesheet is applied to the source data by the XSLT engine to extract the SELECT statement from the encapsulating XML:

```
<?xml version=‘1.0’?>
<xsl:stylesheet version=“1.0”
xmlns:xsl=“http://www.w3.org/1999/XSL/Transform”>
    <xsl:output method=“html” indent=“yes”/>
    <xsl:preserve-space elements=“*”/>
    <!-- <xsl:template match=“/”>
        <xsl:apply-templates/>
    </xsl:template> -->
    <xsl:template match=“sql”>
        <xsl:value-of select=“text( )”/>
    </xsl:template>
    <xsl:template match=“SQLERR”></xsl:template>
    <xsl:template match=“GENSQL”></xsl:template>
</xsl:stylesheet>
```

The result of processing the source data in conjunction with the stylesheet in this example would be the text:

SELECT * FROM DBC.INFO

The following example illustrates how versioning of stylesheets provides additional flexibility. In this example stylesheet pterun version 1.0 is as follows:

```
<?xml version=‘1.0’?>
<xsl:stylesheet version=“1.0”
xmlns:xsl=“http://www.w3.org/1999/XSL/Transform”>
    <xsl:output method=“html” indent=“yes”/>
    <xsl:preserve-space elements=“*”/>
    <xsl:template match=“/”>
        <xsl:apply-templates/>
    </xsl:template>
    <xsl:template match=“insert_pte_run”>
      INSERT INTO PTE.PTE_RUN VALUES
        (Serial_Number = <xsl:value-of select=“@serial”/>
          ,Test_Communication_Method_ID = <xsl:value-of
select=“@comm_method_id”/>
          ,Results_Directory = ‘<xsl:value-of
select=“@results_directory”/>’
          ,Test_Parallelism = <xsl:value-of
select=“@parallelism”/>
          ,Web_Based = <xsl:value-of select=“@web_based”/>
          ,Custom_Tfile = <xsl:value-of
select=“@custom_tfile”/>
          ,Results_Directory_Location = ‘<xsl:value-of
select=“@results_dir_location”/>’
          ,Error_List = <xsl:value-of
select=“@error_list”/>
          ,Control_Directory = ‘<xsl:value-of
select=“@control_directory”/>’
          ,Test_Directory = ‘<xsl:value-of
select=“@test_directory”/>’
          ,run_setup = CASE WHEN <xsl:value-of
select=“@run_setup”/> = 1 THEN ‘Y’ ELSE ‘N’ END
          ,run_tests = CASE WHEN <xsl:value-of
select=“@run_tests”/> = 1 THEN ‘Y’ ELSE ‘N’ END
          ,run_cleanup = CASE WHEN <xsl:value-of
select=“@run_cleanup”/> = 1 THEN ‘Y’ ELSE ‘N’ END
          ,exec_directory = ‘<xsl:value-of
select=“@exec_directory”/>’
          ,pfile_name = ‘<xsl:value-of
select=“@pfile_name”/>’
          ,tfile_name = ‘<xsl:value-of
select=“@tfile_name”/>’
          ,client_port = ‘<xsl:value-of
select=“@client_port”/>’);
    </xsl:template>
    <!-- <xsl:template match=“*”></xsl:template> -->
</xsl:stylesheet>
```

Whereas stylesheet pterun version 2.0 is the following:

```
<?xml version=‘1.0’?>
<xsl:stylesheet version=“1.0”
xmlns:xsl=“http://www.w3.org/1999/XSL/Transform”>
    <xsl:output method=“html” indent=“yes”/>
    <xsl:preserve-space elements=“*”/>
    <xsl:template match=“/”>
        <xsl:apply-templates/>
    </xsl:template>
    <xsl:template match=“insert_pte_run”>
      CALL MyProcedure (<xsl:value-of select=“@serial”/>
          ,<xsl:value-of select=“@comm_method_id”/>
          ,‘<xsl:value-of select=“@results_directory”/>’
          ,<xsl:value-of select=“@parallelism”/>
          ,<xsl:value-of select=“@web_based”/>
          ,<xsl:value-of select=“@custom_tfile”/>
          ,‘<xsl:value-of
select=“@results_dir_location”/>’
          ,<xsl:value-of select=“@error_list”/>
          ,‘<xsl:value-of select=“@control_directory”/>’
          ,‘<xsl:value-of select=“@test_directory”/>’
          ,<xsl:value-of select=“@run_setup”/>
          ,<xsl:value-of select=“@run_tests”/>
          ,<xsl:value-of select=“@run_cleanup”/>
          ,‘<xsl:value-of select=“@exec_directory”/>’
          ,‘<xsl:value-of select=“@pfile_name”/>’
          ,‘<xsl:value-of select=“@tfile_name”/>’
          ,‘<xsl:value-of select=“@client_port”/>’);
    </xsl:template>
    <!-- <xsl:template match=“*”></xsl:template> -->
    </xsl:stylesheet>
```

Transformations on source data can use either version 1.0 or version 2.0 of the pterun stylesheet. For example, the following source data would be processed in conjunction with version 1.0 of the pterun stylesheet:

```
<?xml version=“1.0” ?>
<?xml-stylesheet type=“text/xsl” href=“pterun.1.0.xsl”?>
<message xmlns:xsi=“http://www.w3.org/2001/XMLSchema-
instance”
xsi:noNamespaceSchemaLocation=“http://ttc.sandiegoca.ncr.com/
schema/pte/pterun.1.0.xsd”>
  <insert_pte_run serial=“764659” comm_method_id=“1”
results_directory=“YK160001_udttrignft_pte23138_r1”
parallelism=“1” web_based=“1” custom_tfile=“0”
results_dir_location=“RB” error_list=“1”
control_directory=“/home/pte_dev/temp/yk160001/NFT/
UDT_Trigger_SP_NFT/network/CTRL_MPRAS_MPRAS_BASE”
test_directory=“/home/pte_dev/temp/yk160001/NFT/
UDT_Trigger_SP_NFT/network” run_setup=“1” run_tests=“1”
run_cleanup=“0” exec_directory=“UDT_Trigger_SP_NFT”
pfile_name=“” tfile_name=“” client_port=“”/>
    </message>
```

On the other hand, the following source data would be processed in conjunction with version 2.0 of the pterun stylesheet:

```
<?xml version=“1.0” ?>
<?xml-stylesheet type=“text/xsl” href=“pterun.2.0.xsl”?>
<message xmlns:xsi=“http://www.w3.org/2001/XMLSchema-
instance”
xsi:noNamespaceSchemaLocation=“http://ttc.sandiegoca.ncr.com/
schema/pte/pterun.2.0.xsd”>
  <insert_pte_run serial=“764659” comm_method_id=“1”
results_directory=“YK160001_udttrignft_pte23138_r1”
parallelism=“1” web_based=“1” custom_tfile=“0”
results_dir_location=“RB” error_list=“1”
control_directory=“/home/pte_dev/temp/yk160001/NFT/
UDT_Trigger_SP_NFT/network/CTRL_MPRAS_MPRAS_BASE”
test_directory=“/home/pte_dev/temp/yk160001/NFT/
UDT_Trigger_SP_NFT/network” run_setup=“1” run_tests=“1”
run_cleanup=“0” exec_directory=“UDT_Trigger_SP_NFT”
pfile_name=“” tfile_name=“” client_port=“”/>
    </message>
```

The above techniques provide a method for transforming source XML files into executable database query language statements based on a library of XSL stylesheets. The techniques provide a transformation solution that is flexible and simple to configure for a wide variety of database query statements.

The text above describes one or more specific embodiments of a broader invention. The invention also is carried out in a variety of alternative embodiments and thus is not limited to those described here. Those other embodiments are also within the scope of the following claims.

We claim:

1. A method of converting source data encapsulated in an extensible language format into executable statements in a database query language comprising:
maintaining a library of one or more stylesheets compatible with the extensible language format, the one or more stylesheets configured to identify data elements in the source data that are specified by the stylesheets and to perform one or more transformations specified by the one or more stylesheets on the one or more data elements identified;
receiving source data in the extensible language format;
applying one or more of the stylesheets from the library to the source data and performing any specified transformations on the source data; and
sending the transformed data to a Database Management System (DBMS) as an executable database query language statement.

2. The method of claim 1 wherein the extensible language format is Extensible Markup Language (XML).

3. The method of claim 2 wherein the one or more stylesheets in the stylesheet library are Extensible Stylesheet Language (XSL) stylesheets.

4. The method of claim 3 wherein the one or more stylesheets from the library are applied to the source data by an Extensible Stylesheet Language Transformation (XSLT) engine.

5. The method of claim 1 wherein the source data specifies which stylesheets from the library should be applied to the source data.

6. The method of claim 1 wherein the source data specifies which version of one or more specified stylesheets from the library should be applied to the source data.

7. A system for converting source data encapsulated in an extensible language format into executable statements in a database query language, where the system is configured to:
maintain a library of one or more stylesheets compatible with the extensible language format, the one or more stylesheets configured to identify data elements in the source data that are specified by the stylesheets and to perform one or more transformations specified by the one or more stylesheets on the one or more data elements identified;
receive source data in the extensible language format;
apply one or more of the stylesheets from the library to the source data and perform any specified transformations on the source data; and
send the transformed data to a Database Management System (DBMS) as an executable database query language statement.

8. A computer program stored on tangible storage media comprising executable instructions for performing a method of converting source data encapsulated in an extensible language format into executable statements in a database query language, the method comprising:
maintaining a library of one or more stylesheets compatible with the extensible language format, the one or more stylesheets configured to identify data elements in the source data that are specified by the stylesheets and to perform one or more transformations specified by the one or more stylesheets on the one or more data elements identified;
receiving source data in the extensible language format;
applying one or more of the stylesheets from the library to the source data and performing any specified transformations on the source data; and
sending the transformed data to a Database Management System (DBMS) as an executable database query language statement.
